(19) United States
(12) Patent Application Publication
(10) Pub. No.: US 2024/0304869 A1
(43) Pub. Date: Sep. 12, 2024

(54) LFP Battery Cell Configured Such that SOC Measurement is Easily Performed

(71) Applicant: LG Energy Solution, Ltd., Seoul (KR)

(72) Inventors: Jun Woo Huh, Daejeon (KR); Ki Woong Kim, Daejeon (KR)

(73) Assignee: LG Energy Solution, Ltd., Seoul (KR)

(21) Appl. No.: 18/279,544

(22) PCT Filed: Oct. 7, 2022
(86) PCT No.: PCT/KR2022/015117

§ 371 Date: Aug. 30, 2023

(30) Foreign Application Priority Data
Oct. 18, 2021 (KR) 10-2021-0138151

(51) Int. Cl. H01M 10/0585; H01M 4/02; H01M 4/505; H01M 4/525; H01M 4/58; H01M 10/052; H01M 10/48; H01M 50/531

(52) U.S. Cl. CPC H01M 10/0585; H01M 4/505; H01M 4/525; H01M 4/5825; H01M 10/052; H01M 10/48; H01M 50/531; H01M 2004/028

(57) ABSTRACT

An LFP battery cell includes an electrode assembly having at least one first mono-cell and at least one second mono-cell received in a battery case. Each of the first mono-cell and the second mono-cell includes a positive electrode tab and a negative electrode tab. The positive electrode tab of the first mono-cell protrudes in the same direction as the positive electrode tab of the second mono-cell but does not overlap the positive electrode tab of the second mono-cell, whereby SoC of the LFP battery cell is easily measured.

### CROSS-REFERENCE TO RELATED APPLICATIONS

This application is a national phase entry under 35 U.S.C. § 371 of International Application No. PCT/KR2022/015117, filed Oct. 7, 2022, which claims the benefit of priority to Korean Patent Application No. 2021-0138151 filed on Oct. 18, 2021, the disclosures of which are incorporated herein by reference in their entirety.

### TECHNICAL FIELD

The present invention relates to an LFP battery cell including an electrode assembly configured such that one mono-cell using NCM as a positive electrode active material and a plurality of mono-cells using LFP as a positive electrode active material are stacked, whereby SoC of a battery cell using LFP as a positive electrode active material is easily measured.

### BACKGROUND ART

With technological development of mobile devices, such as smartphones, laptop computers, and digital cameras, and an increase in demand therefor, research on secondary batteries, which are capable of being charged and discharged, has been actively conducted. In addition, secondary batteries, which are energy sources substituting for fossil fuels causing air pollution, have been applied to an electric vehicle (“EV”), a hybrid electric vehicle (“HEV”), a plug-in hybrid electric vehicle (“P-HEV”), and an energy storage system (“ESS”).

In general, a lithium secondary battery includes an electrode assembly and a battery case configured to receive the electrode assembly and an electrolytic solution.

Here, the electrode assembly is generally classified as a jelly-roll type assembly, a stacked type assembly, a stacked and folded type electrode assembly, or a laminated and stacked type assembly. A jelly-roll type assembly is one in which a long sheet type positive electrode and a long sheet type negative electrode are wound in the state in which a separator is interposed therebetween. A stacked type assembly is one in which a rectangular positive electrode and a rectangular negative electrode are stacked in the state in which a separator is interposed therebetween. A stacked and folded type electrode assembly is one in which unit cells are wound using a long separation film. A laminated and stacked type assembly is one in which battery cells are stacked in the state in which a separator is interposed therebetween and are then attached to each other.

A general structure of a conventional stacked electrode assembly is shown in FIGS. 1 and 2, in which a plurality of mono-cells is stacked, each of the mono-cells being configured such that a positive electrode 10, a separator 30, a negative electrode 20, and a separator 30 are sequentially stacked.

After the plurality of mono-cells is stacked, positive electrode tabs 11 are joined to each other by welding to form a positive electrode tab bundle, and negative electrode tabs 21 are also joined to each other to form a negative electrode tab bundle.

A lithium-cobalt-based oxide, a lithium-nickel-based oxide, a lithium-manganese-based oxide, or a lithium composite oxide is used as a positive electrode active material.

Conventionally, lithium nickel cobalt manganese oxide (LiNiₓCo_{y}Mn_{z}O₂ (x+y+z=1), (“NCM”)), which has advantages in terms of charge and discharge capacity and operating voltage, was mainly used as the positive electrode active material. With recent rise of a problem related to safety of a battery in the field of electric vehicles (“EVs”), however, a battery using lithium iron phosphate (LiFePO₄, (“LFP”)), which exhibits relative high safety and has low material cost, as the positive electrode active material has attracted attention.

As a result, various attempts to manufacture a positive electrode active material using lithium iron phosphate and to manufacture a battery having the same applied thereto have been made, as in Korean Patent Application Publication No. 2014-0066414.

Meanwhile, the manufactured battery is used as a power source for various kinds of devices, and accurate information about state of charge (“SoC”) of the battery is essential to stably use the battery.

Various SoC measurement methods are used, and voltage measurement is widely used as the simplest method, even if an error occurs depending on the temperature.

As shown in FIG. 3, however, a battery having LFP applied thereto has a characteristic in that a change in open circuit voltage (“OCV”) during an appropriate use period is smaller than in another kind of lithium ion battery. That is, a period during which voltage is flat is long, whereby it is difficult to accurately measure SoC.

As a result, it is difficult to predict the charged state of the battery having LFP applied thereto, and the measured value of SoC may be different from actual capacity.

Meanwhile, Korean Patent Application Publication No. 2018-0079771 discloses a method of calibrating SoC of an LFP battery; however, the structure is very complicated, as it includes a voltage and current measurement unit, a temperature measurement unit, a memory unit, and a controller configured to individually receive a voltage value and a current value, in order to perform calibration and to determine SoC.

### DISCLOSURE

### Technical Problem

The present disclosure has been made in view of the above problems, and one aspect of the present invention is to provide an LFP battery cell configured such that SoC measurement is easily performed.

Another aspect of the present invention is to provide an LFP battery cell configured such that reliability of a measured SoC value is improved.

### Technical Solution

An LFP battery cell according to aspects of the present invention includes an electrode assembly having at least one first mono-cell and at least one second mono-cell and a battery case configured to receive the electrode assembly. Each of the first mono-cell and the second mono-cell includes a positive electrode tab and a negative electrode tab. The positive electrode tabs are formed in a direction in which the positive electrode tabs face each other, and the negative electrode tabs being formed in a direction in which the negative electrode tabs face each other. The positive electrode tab of the first mono-cell protrudes in the same direction as the positive electrode tab of the second mono-cell but does not overlap the positive electrode tab of the second mono-cell.

Also, in the LFP battery cell according to aspects of the present invention, each of the first mono-cell and the second mono-cell may be a mono-cell configured such that a positive electrode, a separator, a negative electrode, and a separator are sequentially stacked.

Also, in the LFP battery cell according to aspects of the present invention, each of the first mono-cell and the second mono-cell may be a mono-cell configured such that a negative electrode, a separator, a positive electrode, and a separator are sequentially stacked.

Also, in the LFP battery cell according to aspects of the present invention, the negative electrode tab of the first mono-cell and the negative electrode tab of the second mono-cell may overlap each other to form a negative electrode tab bundle.

Also, in the LFP battery cell according to aspects of the present invention, the positive electrode (110) of the first mono-cell may be formed using lithium nickel-cobalt-manganese oxide (LiNiₓCo_{y}Mn_{z}O₂, NCM) as an active material.

Also, in the LFP battery cell according to aspects of the present invention, the positive electrode (210) of the second mono-cell may be formed using lithium iron phosphate oxide (LiFePO₄, LFP) as an active material.

Also, in the LFP battery cell according to aspects of the present invention, the electrode assembly may include only one of the first mono-cell.

Also, in the LFP battery cell according to aspects of the present invention, the electrode assembly may include two or more of the second mono-cell.

Also, in the LFP battery cell according to aspects of the present invention, the first mono-cell may be located between the stacked second mono-cells.

Also, in the LFP battery cell according to aspects of the present invention, the electrode assembly may further include a half-cell configured such that a separator, a negative electrode, and a separator are sequentially stacked on at least one of the uppermost part and the lowermost part of the electrode assembly.

Also, in the LFP battery cell according to aspects of the present invention, the half-cell may be stacked on any one of the uppermost part and the lowermost part of the electrode assembly at which the outermost electrode is a positive electrode.

In addition, a method of manufacturing an LFP battery cell according to aspects of the present invention includes a) manufacturing a first mono-cell including a positive electrode formed using lithium nickel-cobalt-manganese oxide (LiNiₓCo_{y}Mn_{z}O₂, NCM) as a positive electrode active material and manufacturing a second mono-cell including a positive electrode formed using lithium iron phosphate oxide (LiFePO₄, LFP) as a positive electrode active material, b) stacking at least one first mono-cell and at least one second mono-cell to manufacture an electrode assembly, and c) receiving the electrode assembly in a battery case.

Also, in the method according to aspects of the present invention, each of the first mono-cell and the second mono-cell may include a positive electrode tab and a negative electrode tab. The positive electrode tab of the first mono-cell may protrude in the same direction as the positive electrode tab of the second mono-cell but may not overlap the positive electrode tab of the second mono-cell after manufacture of the electrode assembly.

Also, in the method according to aspects of the present invention, step b) may include stacking a half-cell, configured such that a separator, a negative electrode, and a separator are sequentially formed, on at least one of the uppermost part and the lowermost part of the electrode assembly.

### Advantageous Effects

An LFP battery cell according to aspects of the present invention has an advantage in that a first mono-cell formed using NCM as a positive electrode active material is included and voltage of the first mono-cell is measured, whereby it is possible to easily and accurately measure SoC of the LFP battery cell.

In addition, the LFP battery cell according to aspects of the present invention has an advantage in that a half-cell is included in order to manufacture a negative electrode such that the capacity of the negative electrode is larger, whereby it is possible to inhibit lithium precipitation even in a situation such as overcharging.

### DESCRIPTION OF DRAWINGS

FIG. 1 is an exploded perspective view schematically showing an electrode assembly constituted by two stacked conventional mono-cells.

FIG. 2 is a perspective view schematically showing the electrode assembly constituted by the two stacked conventional mono-cells.

FIG. 3 is a graph schematically showing an OCV-SoC curve of each of an LFP battery and a general lithium ion battery.

FIG. 4 is an exploded perspective view schematically showing an electrode assembly constituted by a first mono-cell and a second mono-cell according to an embodiment of the present invention.

FIG. 5 is a perspective view of the electrode assembly in the state in which the mono-cells according to the embodiment shown in FIG. 4 are stacked.

FIG. 6 is a plan view of the electrode assembly according to the embodiment shown in FIG. 5.

FIG. 7 is an exploded perspective view schematically showing an electrode assembly constituted by a first mono-cell, a second mono-cell, and a half-cell according to another embodiment of the present invention.

FIG. 8 is a perspective view of the electrode assembly in the state in which the mono-cells and the half-cell according to the other embodiment shown in FIG. 7 are stacked.

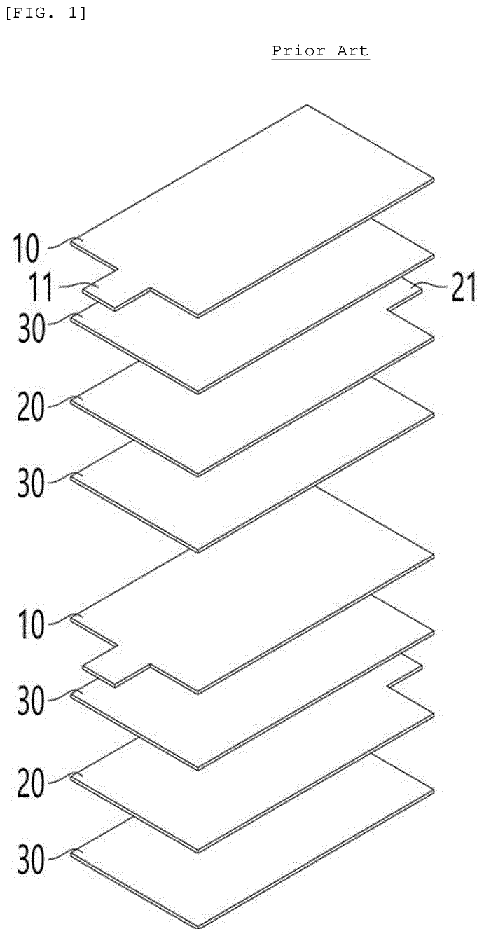

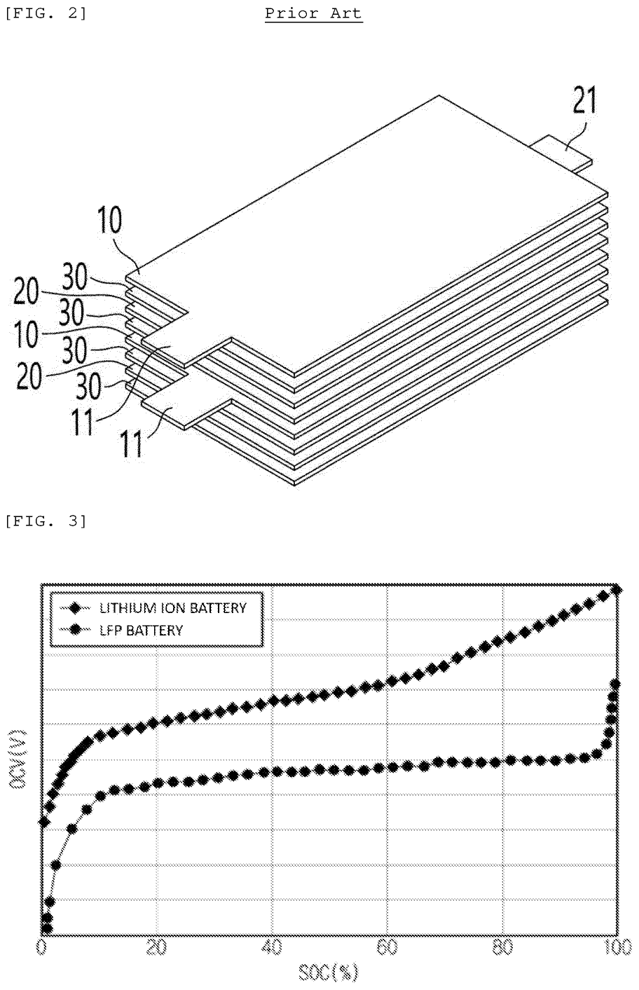

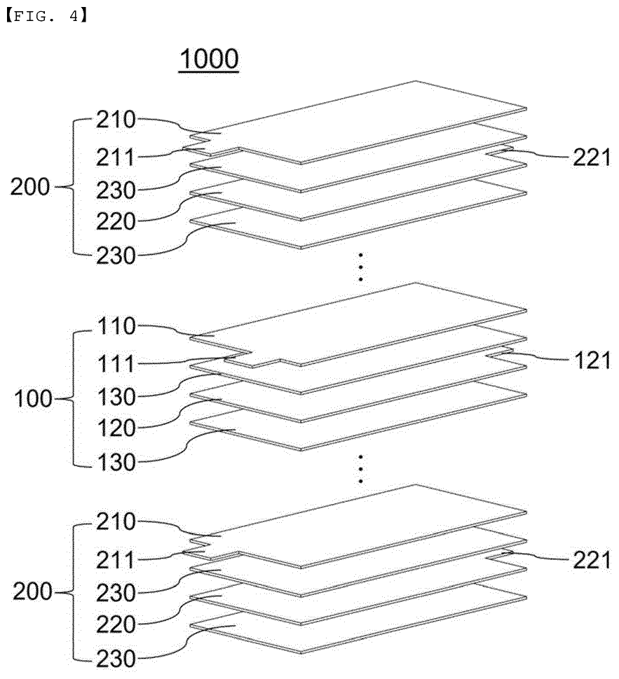

### BEST MODE

In the present application, it should be understood that the terms “comprises,” “has,” “includes,” etc. specify the presence of stated features, numbers, steps, operations, elements, components, or combinations thereof, but do not preclude the presence or addition of one or more other features, numbers, steps, operations, elements, components, or combinations thereof.

In addition, the same reference numbers will be used throughout the drawings to refer to parts that perform similar functions or operations. In the case in which one part is said to be connected to another part in the specification, not only may the one part be directly connected to the other part, but also, the one part may be indirectly connected to the other part via a further part. In addition, that a certain element is included does not mean that other elements are excluded, but means that such elements may be further included unless mentioned otherwise.

Hereinafter, an LFP battery cell according to embodiments of the present invention will be described in detail with reference to the accompanying drawings.

In general, a battery cell, which is configured such that an electrode assembly and an electrolytic solution are received in a battery case, may be classified as a prismatic battery cell, a cylindrical battery cell, or a pouch-shaped battery cell depending on the shape of the battery case.

A pouch-shaped case is generally configured to have a laminate sheet structure including an inner layer, a metal layer, and an outer layer. The inner layer is disposed in direct contact with the electrode assembly, and therefore the inner layer must exhibit high insulation properties and high resistance to an electrolytic solution. In addition, the inner layer must exhibit high sealability in order to hermetically seal the pouch-shaped case from the outside, i.e. a thermally-bonded sealed portion between inner layers must exhibit excellent thermal bonding strength.

The inner layer may be made of a material selected from among a polyolefin-based resin, such as polypropylene, polyethylene, polyethylene acrylate, or polybutylene, a polyurethane resin, and a polyimide resin, which exhibit excellent chemical resistance and high sealability. However, the present invention is not limited thereto, and various kinds of polymer materials that exhibit excellent mechanical properties, such as tensile strength, rigidity, surface hardness, and impact resistance, and excellent chemical resistance, may be used.

The metal layer, which is disposed so as to abut the inner layer, corresponds to a barrier layer configured to prevent moisture or various kinds of gas from permeating into the battery from the outside. An aluminum thin film, which is lightweight and easily shapeable, may be used as a preferred material for the metal layer.

The outer layer is provided on the other surface of the metal layer. The outer layer may be made of a heat-resistant polymer that exhibits excellent tensile strength, resistance to moisture permeation, and resistance to air transmission such that the outer layer exhibits high heat resistance and chemical resistance while protecting the electrode assembly. As an example, the outer layer may be made of nylon or polyethylene terephthalate; however, the present invention is not limited thereto.

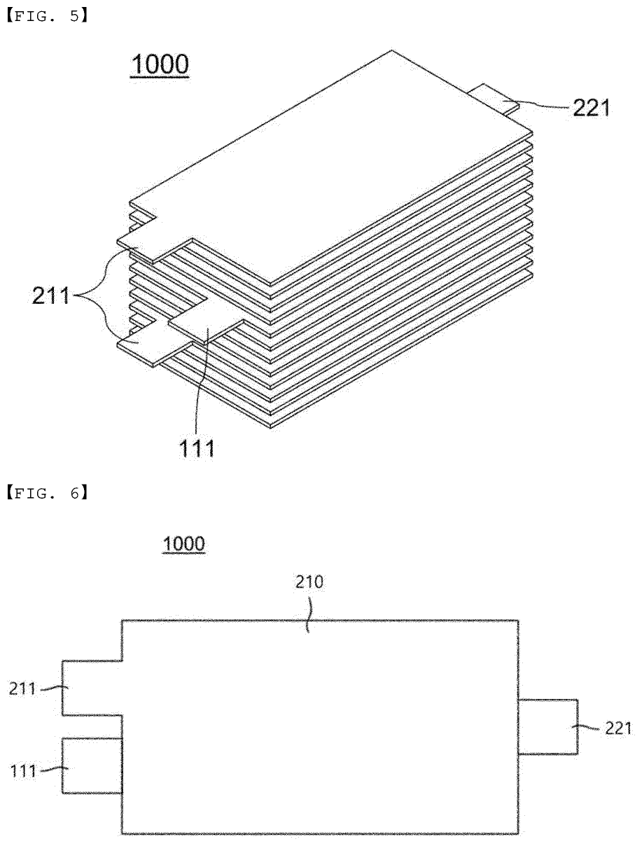

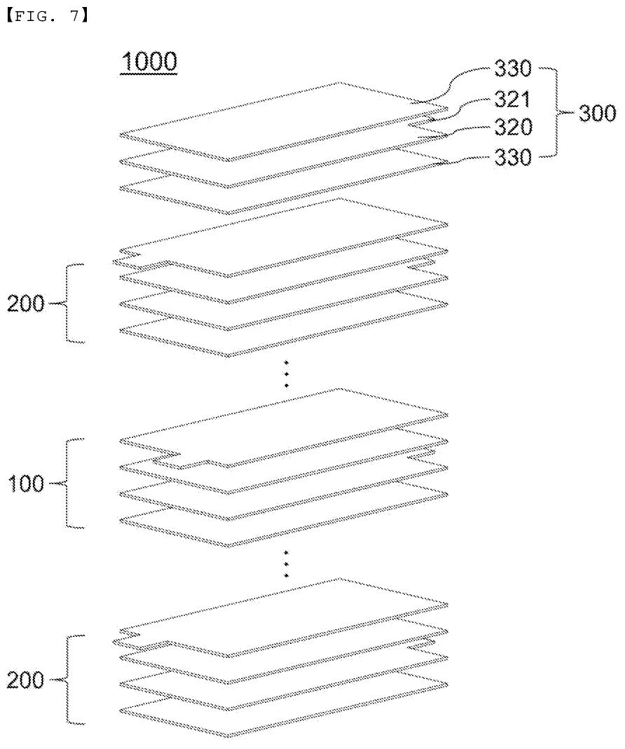

FIG. 4 is an exploded perspective view schematically showing an electrode assembly constituted by a first mono-cell and a second mono-cell according to an embodiment of the present invention, FIG. 5 is a perspective view of the electrode assembly in the state in which the mono-cells according to the embodiment shown in FIG. 4 are stacked, and FIG. 6 is a plan view of the electrode assembly according to the embodiment shown in FIG. 5.

Referring to FIGS. 4 to 6, the electrode assembly 1000, which is applied to an LFP battery cell configured such that state of charge (SoC) measurement is easily performed, is configured to have a structure in which at least one first mono-cell 100 and at least one second mono-cell 200 are stacked.

Here, the first mono-cell 100 is a mono-cell configured such that a positive electrode 110, a separator 130, a negative electrode 120, and a separator 130 are sequentially stacked, and a positive electrode tab 111 and a negative electrode tab 121 protrude in a direction in which the positive electrode tab and the negative electrode tab face each other.

Meanwhile, the second mono-cell 200 is a mono-cell configured such that a positive electrode 210, a separator 230, a negative electrode 220, and a separator 230 are sequentially stacked, and a positive electrode tab 211 and a negative electrode tab 221 protrude in a direction in which the positive electrode tab and the negative electrode tab face each other.

In FIGS. 4 to 6, each of the first mono-cell 100 and the second mono-cell 200 is shown as having the structure in which the positive electrode, the separator, the negative electrode, and the separator are sequentially stacked; however, the present invention is not limited thereto, and each of the mono-cells may also be configured such that a negative electrode, a separator, a positive electrode, and a separator are sequentially stacked.

When the first mono-cell 100 and the second mono-cell 200 are stacked to form the electrode assembly, as shown in FIGS. 4 to 6, the positive electrode tab 111 of the first mono-cell and the positive electrode tab 211 of the second mono-cell protrude in the same direction but do not overlap each other.

As a result, only the positive electrode tabs 211 of the second mono-cells overlap each other to form a positive electrode tab bundle, and the positive electrode tab 111 of the first mono-cell is separately located, as shown in FIG. 5.

In contrast, the negative electrode tab 121 of the first mono-cell and the negative electrode tab 221 of the second mono-cell protrude in the same direction while overlapping each other to form a negative electrode tab bundle.

Here, the positive electrode 210 of the second mono-cell 200 may be formed using lithium iron phosphate oxide (LiFePO₄, LFP) as an active material.

As previously described, an LFP battery cell using LFP as a positive electrode active material has an advantage in terms of safety but has difficulty in measuring SoC using voltage in order to check the charged state of the battery cell.

In order to easily measure SoC of the LFP battery cell, therefore, it is preferable to form an electrode assembly 1000 by stacking a first mono-cell 100 formed using lithium nickel-cobalt-manganese oxide (LiNiₓCo_{y}Mn_{z}O₂, NCM) as a positive electrode active material and the second mono-cell 200.

Here, it is preferable for x, y, and z, which are constants, to satisfy x+y+z=1; however, the present invention is not limited thereto, and a known NCM battery cell may be used.

When the LFP mono-cell and the NCM mono-cell are stacked, it is possible to accurately measure SoC using NCM, in which voltage change linearly occurs in an operating voltage period. That is, when the electrode assembly 1000 is formed only by adding the first mono-cell 100, it is possible to more accurately measure SoC of the LFP battery cell.

Meanwhile, the first mono-cell 100 and the second mono-cell 200 may be formed using the same separators 130 and 230 and the same negative electrodes 120 and 220.

FIGS. 4 and 5 show that one first mono-cell 100 and two second mono-cells 200 are stacked in the state in which the first mono-cell is located between the two second mono-cells. However, the electrode assembly 1000 according to the present invention is not limited thereto, and the electrode assembly 1000 may be configured so as to have any of various other structures, such as a structure including one first mono-cell 100 and three or more second mono-cells 200, a structure including a plurality of first mono-cells 100 and a plurality of second mono-cells 200, and a structure including one first mono-cell 100 and one second mono-cell 200.

When one first mono-cell 100 and two or more second mono-cells 200 are used, the first mono-cell 100 may be located at an outer part of the electrode assembly 1000. However, it is more preferable for the first mono-cell 100 to be interposed between the second mono-cells 200 in order to improve accuracy in measuring SoC of the entirety of the battery cell.

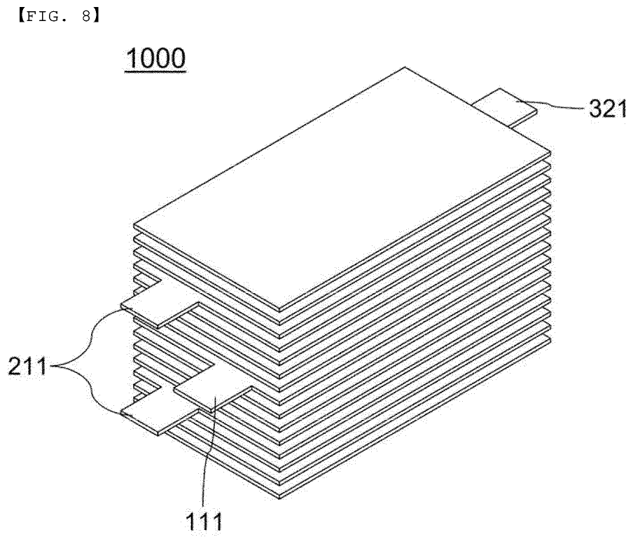

FIG. 7 is an exploded perspective view schematically showing an electrode assembly constituted by a first mono-cell, a second mono-cell, and a half-cell according to another embodiment of the present invention, and FIG. 8 is a perspective view of the electrode assembly in the state in which the mono-cells and the half-cell according to the other embodiment shown in FIG. 7 are stacked.

The electrode assembly according to the other embodiment of the present invention shown in FIGS. 7 and 8 is identical in construction to the electrode assembly according to the embodiment described with reference to FIGS. 4 to 6 except that the half-cell is further stacked. Hereinafter, therefore, only a description related to the half-cell will be given.

The half-cell 300 is configured such that a separator 330, a negative electrode 320, and a separator 330 are stacked. The reason that the half-cell 300 is stacked is that it is necessary to dispose a negative electrode as the outermost electrode of the electrode assembly 1000.

The reason that the half-cell 300 is added such that the number of negative electrodes is greater than the number of positive electrodes in the electrode assembly 1000, as described above, is that the capacity of the negative electrodes is configured so as to be greater than the capacity of the positive electrodes, whereby it is possible to inhibit lithium precipitation even in a situation of overcharging.

FIG. 7 shows that the half-cell 300 is located on top, which, however, is merely an example, and it is obvious that the half-cell 300 may be located at the bottom by changing or adjusting the positions of the positive electrodes and the negative electrodes constituting the first mono-cell 100 and the second mono-cell 200.

The LFP battery cell including the NCM mono-cell described above may constitute a battery module or a battery pack so as to be used in a battery for mobile devices, such as a laptop computer, or vehicles. In addition, the NCM mono-cell may be used to measure voltage of the LFP battery cell.

Hereinafter, a method of manufacturing the LFP battery cell configured such that SoC measurement is easily performed will be described.

The LFP battery cell manufacturing method includes a) a step of manufacturing a first mono-cell including a positive electrode formed using lithium nickel-cobalt-manganese oxide (LiNiₓCo_{y}Mn_{z}O₂, NCM) as a positive electrode active material, b) a step of manufacturing a second mono-cell including a positive electrode formed using lithium iron phosphate oxide (LiFePO₄, LFP) as a positive electrode active material, c) a step of stacking at least one first mono-cell and at least one second mono-cell to manufacture an electrode assembly, and d) a step of receiving the electrode assembly in a battery case.

As previously described, it is preferable for x, y, and z, which are constants, to satisfy x+y+z=1; however, the present invention is not limited thereto.

In step c), each of the first mono-cell and the second mono-cell includes a positive electrode tab and a negative electrode tab, and the first mono-cell and the second mono-cell are stacked such that the positive electrode tab of the first mono-cell and the positive electrode tab of the second mono-cell protrude in the same direction but do not overlap each other.

Although step b) of manufacturing the second mono-cell including the positive electrode formed using LiFePO₄ (LFP) as the positive electrode active material is performed after step a) of manufacturing the first mono-cell including the positive electrode formed using LiNiₓCo_{y}Mn_{z}O₂ (NCM) as the positive electrode active material, step a) and step b) may be simultaneously performed or step a) may be performed after step b).

In addition, step c) may include a step of stacking a half-cell, configured such that a separator, a negative electrode, and a separator are sequentially formed, on at least one of the uppermost part and the lowermost part of the electrode assembly.

An electrolytic solution injection step, an activation step, and a sealing step are identical to known battery cell manufacturing steps, and therefore a detailed description thereof will be omitted.

Although the specific details of the present invention have been described in detail, those skilled in the art will appreciate that the detailed description thereof discloses only preferred embodiments of the present invention and thus does not limit the scope of the present invention. Accordingly, those skilled in the art will appreciate that various changes and modifications are possible, without departing from the category and the technical idea of the present invention, and it will be obvious that such changes and modifications fall within the scope of the appended claims.

### DESCRIPTION OF REFERENCE NUMERALS

1000: Electrode assembly
100: First mono-cell
110: Positive electrode of first mono-cell
111: Positive electrode tab of first mono-cell
120: Negative electrode of first mono-cell
121: Negative electrode tab of first mono-cell
130: Separator of first mono-cell
200: Second mono-cell
210: Positive electrode of second mono-cell
211: Positive electrode tab of second mono-cell
220: Negative electrode of second mono-cell
221: Negative electrode tab of second mono-cell
230: Separator of second mono-cell
300: Half-cell
320: Negative electrode of half-cell
321: Negative electrode tab of half-cell
330: Separator of half-cell

1. An LFP battery cell comprising:
an electrode assembly comprising at least one first mono-cell and at least one second mono-cell stacked into a stack along a stacking direction; and
a battery case configured to receive the electrode assembly, wherein
each of the first mono-cell and the second mono-cell comprises a positive electrode tab and a negative electrode tab, and
the positive electrode tab of the first mono-cell protrudes from the same side of the stack as the positive electrode tab of the second mono-cell but does not overlap the positive electrode tab of the second mono-cell along the stacking direction.

2. The LFP battery cell according to claim 1, wherein each of the first mono-cell and the second mono-cell is a mono-cell including a positive electrode, a separator, a negative electrode, and a separator stacked in that order.

3. The LFP battery cell according to claim 1, wherein each of the first mono-cell and the second mono-cell is a mono-cell including a negative electrode, a separator, a positive electrode, and a separator stacked in that order.

4. The LFP battery cell according to claim 1, wherein the negative electrode tab of the first mono-cell and the negative electrode tab of the second mono-cell overlap each other along the stacking direction so as to form a negative electrode tab bundle.

5. The LFP battery cell according to claim 1, wherein a positive electrode of the first mono-cell is formed using lithium nickel-cobalt-manganese oxide (LiNiₓCo_{y}Mn_{z}O₂, NCM) (where x+y+z=1) as an active material.

6. The LFP battery cell according to claim 5, wherein a positive electrode of the second mono-cell is formed using lithium iron phosphate oxide (LiFePO₄, LFP) as an active material.

7. The LFP battery cell according to claim 1, wherein the electrode assembly includes only one of the first mono-cell.

8. The LFP battery cell according to claim 7, wherein the electrode assembly includes two or more of the second mono-cell.

9. The LFP battery cell according to claim 8, wherein the first mono-cell is located between the stacked second mono-cells.

10. The LFP battery cell according to claim 1, wherein the electrode assembly further comprises a half-cell including a separator, a negative electrode, and a separator stacked in that order, the half-cell being stacked on at least one of an uppermost part and a lowermost part of the electrode assembly in the stacking direction.

11. The LFP battery cell according to claim 10, wherein the half-cell is stacked on an outermost electrode of the uppermost part or the lowermost part of the electrode assembly, wherein the outermost electrode is a positive electrode.

12. A method of manufacturing an LFP battery cell, the method comprising:
a) manufacturing a first mono-cell comprising a positive electrode formed using lithium nickel-cobalt-manganese oxide (LiNiₓCo_{y}Mn_{z}O₂, NCM) (where x+y+z=1) as a positive electrode active material and manufacturing a second mono-cell comprising a positive electrode formed using lithium iron phosphate oxide (LiFePO₄, LFP) as a positive electrode active material;
b) stacking at least one first mono-cell and at least one second mono-cell into a stack along a stacking direction so as to manufacture an electrode assembly; and
c) receiving the electrode assembly in a battery case.

13. The method according to claim 12, wherein
each of the first mono-cell and the second mono-cell comprises a positive electrode tab and a negative electrode tab, and
the positive electrode tab of the first mono-cell protrudes from the same side of the stack as the positive electrode tab of the second mono-cell but does not overlap the positive electrode tab of the second mono-cell along the stacking direction.

14. The method according to claim 12, wherein step b) comprises stacking a half-cell on at least one of an uppermost part and a lowermost part of the electrode assembly in the stacking direction, the half-cell including a separator, a negative electrode, and a separator stacked in that order.
